(19) United States
(12) Patent Application Publication
(10) Pub. No.: US 2025/0373800 A1
(43) Pub. Date: Dec. 4, 2025

(54) CODING TREE BLOCK PARTITIONING

(71) Applicant: Tencent America LLC, Palo Alto, CA (US)

(72) Inventors: Madhu PERINGASSERY KRISHNAN, Mountain View, CA (US); Roman CHERNYAK, Santa Clara, CA (US); Xin ZHAO, San Jose, CA (US); Biao WANG, San Jose, PA (US); Lien-Fei CHEN, Palo Alto, CA (US); Shan LIU, San Jose, CA (US)

(73) Assignee: Tencent America LLC, Palo Alto, CA (US)

(21) Appl. No.: 19/301,898

(22) Filed: Aug. 15, 2025

Related U.S. Application Data
(63) Continuation of application No. PCT/US2024/029263, filed on May 14, 2024.
(60) Provisional application No. 63/526,169, filed on Jul. 11, 2023.

(51) Int. Cl. H04N 19/119; H04N 19/167; H04N 19/172; H04N 19/513

(52) U.S. Cl. CPC H04N 19/119; H04N 19/167; H04N 19/172; H04N 19/513

(57) ABSTRACT

Methods and apparatuses for video decoding and video encoding and a method of processing visual media data are included. The apparatus for video decoding includes processing circuitry configured to determine a first region of interest (ROI) in a first reference picture of a current coding tree block (CTB) that is in a current picture. The processing circuitry is configured to determine a subset of allowable partition decisions from a set of partition decisions of the current CTB based at least on first partitioning structures of the first ROI in the first reference picture. The processing circuitry is configured to partition the current CTB based on the subset of allowable partition decisions.

### RELATED APPLICATION

The present application is a continuation of International Application No. PCT/US2024/029263, filed on May 14, 2024, which claims the benefit of priority to U.S. Provisional Application No. 63/526,169, “Method and Apparatus for Improved Coding Tree Block Partitioning” filed on Jul. 11, 2023. The entire disclosures of the prior applications are hereby incorporated herein by reference in their entirety.

### TECHNICAL FIELD

The present disclosure describes aspects generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression can help transmit image/video data across different devices, storage and networks with minimal quality degradation. In some examples, video codec technology can compress video based on spatial and temporal redundancy. In an example, a video codec can use techniques referred to as intra prediction that can compress an image based on spatial redundancy. For example, the intra prediction can use reference data from the current picture under reconstruction for sample prediction. In another example, a video codec can use techniques referred to as inter prediction that can compress an image based on temporal redundancy. For example, the inter prediction can predict samples in a current picture from a previously reconstructed picture with motion compensation. The motion compensation can be indicated by a motion vector (MV).

### SUMMARY

Aspects of the disclosure include methods and apparatuses for video encoding/decoding.

In an aspect, a method of processing visual media data includes processing a bitstream of the visual media data according to a format rule. The bitstream indicates that a current coding tree block (CTB) in a current picture is partitioned based on a reference picture different from the current picture. The format rule specifies that a region of interest (ROI) in the reference picture of the current CTB is determined, the ROI is indicated by a motion vector of a previously coded neighboring CTB of the current CTB, and the previously coded neighboring CTB is in the current picture. The format rule specifies that a subset of allowable partition decisions is determined from a set of partition decisions of the current CTB based at least on partitioning structures of the ROI in the reference picture and the current CTB is partitioned based on the subset of allowable partition decisions.

In an example, the format rule specifies that the reference picture of the current CTB is different from a reference picture of the previously coded neighboring CTB and the motion vector is scaled based on a temporal distance of the reference picture and a temporal distance of the reference picture of the previously coded neighboring CTB.

In an aspect, a method for video encoding includes determining a region of interest (ROI) in a reference picture of a current coding tree block (CTB). The ROI is indicated by one of a motion vector and a block vector of a previously coded neighboring CTB of the current CTB, and the current CTB and the previously coded neighboring CTB are in a current picture. The method for video encoding includes determining a subset of allowable partition decisions from a set of partition decisions of the current CTB based at least on partitioning structures of the ROI in the reference picture and partitioning the current CTB based on the subset of allowable partition decisions. In an example, the one of the motion vector and the block vector is the motion vector, and the reference picture is different from the current picture.

According to an aspect of the disclosure, an apparatus for video decoding includes processing circuitry. The processing circuitry is configured to determine a first region of interest (ROI) in a first reference picture of a current coding tree block (CTB) that is in a current picture, determine a subset of allowable partition decisions from a set of partition decisions of the current CTB based at least on first partitioning structures of the first ROI in the first reference picture, and partition the current CTB based on the subset of allowable partition decisions.

In an aspect, the first ROI in the first reference picture is indicated by one of a motion vector and a block vector of a previously reconstructed neighboring CTB of the current CTB and the previously reconstructed neighboring CTB is in the current picture.

In an example, the first reference picture is the current picture.

In an example, the one of the motion vector and the block vector is the motion vector, and the first reference picture is different from the current picture.

In an aspect, the subset of allowable partition decisions is determined from the set of partition decisions of the current CTB based on at least (i) the first partitioning structures of the first ROI in the first reference picture and (ii) second partitioning structures of a second ROI in a second reference picture of the current CTB.

In an example, the one of the motion vector and the block vector is the motion vector, the first reference picture of the current CTB is different from a reference picture of the previously reconstructed neighboring CTB, and the motion vector is scaled based on a temporal distance associated with the first reference picture and a temporal distance associated with the reference picture of the previously coded neighboring CTB.

In an example, a picture level quantization parameter (QP) associated with the first reference picture satisfies a pre-defined condition.

In an example, a dual tree partitioning is applied to the first reference picture, the first partitioning structures of the first ROI include luma partitioning structures of a luma component in the first ROI, and the subset of allowable partition decisions is determined from the set of partition decisions of the current CTB based on the luma partitioning structures of the first ROI.

In an example, the first partitioning structures of the first ROI include luma partitioning structures of a luma component in the first ROI and chroma partitioning structures of a chroma component in the first ROI, and the subset of allowable partition decisions is determined from the set of partition decisions of the current CTB based on the luma partitioning structures and the chroma partitioning structures of the first ROI.

In an example, partitioning structures of each region in the first reference picture are stored in a look up table (LUT), a size of each region is less than or equal to a maximum allowable block size, and the first partitioning structures of the first ROI is obtained from the LUT.

In an aspect, the subset of allowable partition decisions is determined from the set of partition decisions of the current CTB based on the first partitioning structures of the first ROI in the first reference picture and residuals associated with the first reference picture.

In an aspect, the subset of allowable partition decisions is determined from the set of partition decisions of the current CTB based on the first partitioning structures of the first ROI in the first reference picture and at least one of (i) a quantization parameter (QP) associated with the first reference picture and a QP associated with the current picture.

In an aspect, the subset of allowable partition decisions is determined from the set of partition decisions of the current CTB based on the first partitioning structures of the first ROI in the first reference picture and a temporal distance between the first reference picture and the current picture.

In an example, the current picture is an inter coded picture.

In an example, the current picture is an intra coded picture.

In an example, contexts for entropy decoding control flags associated with respective partition decisions of the current CTB are determined based at least on the first partitioning structures of the first ROI. Partition decisions of the current CTB may be determined based on the control flags.

Aspects of the disclosure also provide an apparatus for video encoding. The apparatus for video encoding including processing circuitry configured to implement any of the described methods for video encoding.

Aspects of the disclosure also provide a method for video decoding. The method including any of the methods implemented by the apparatus for video decoding.

Aspects of the disclosure also provide a non-transitory computer-readable medium storing instructions which, when executed by a computer, cause the computer to perform any of the described methods for video decoding/encoding.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an example of a block diagram of a communication system (100).

FIG. 2 is a schematic illustration of an example of a block diagram of a decoder.

FIG. 3 is a schematic illustration of an example of a block diagram of an encoder.

FIG. 4 shows an example of intra picture block compensation such as an IBC mode according to an aspect of the disclosure.

FIG. 5 shows an example of intra picture block compensation with one coding tree unit (CTU) size search range and in some examples reuse of the memory for searching some part of a left CTU according to an aspect of the disclosure.

FIG. 6 shows an example of an intra template matching prediction (IntraTMP) mode according to an aspect of the disclosure.

FIG. 7 shows an example of multi-type tree splitting modes according to an aspect of the disclosure.

FIG. 8 shows an example of a signaling mechanism of the partition splitting information in a quadtree with nested multi-type tree coding tree structure according to an aspect of the disclosure.

FIG. 9 shows an example of a CTU divided into multiple coding units (CUs) with a quadtree and nested multi-type tree coding block structure according to an aspect of the disclosure.

FIG. 10 shows an example of separate partitioning structures of a luma coding tree block (CTB) (1020) and a chroma CTB (1010) in a CTU (1002) according to an aspect of the disclosure.

FIG. 11 shows an example of a first region of interest (ROI) in a current picture (1100) that is indicated by a BV (1110) of a previously coded neighboring CTB (1101) of the current CTB (1102) according to an aspect of the disclosure.

FIG. 12 shows a flow chart outlining a decoding process according to some aspects of the disclosure.

FIG. 13 shows a flow chart outlining an encoding process according to some aspects of the disclosure.

FIG. 14 is a schematic illustration of a computer system in accordance with an aspect.

### DETAILED DESCRIPTION

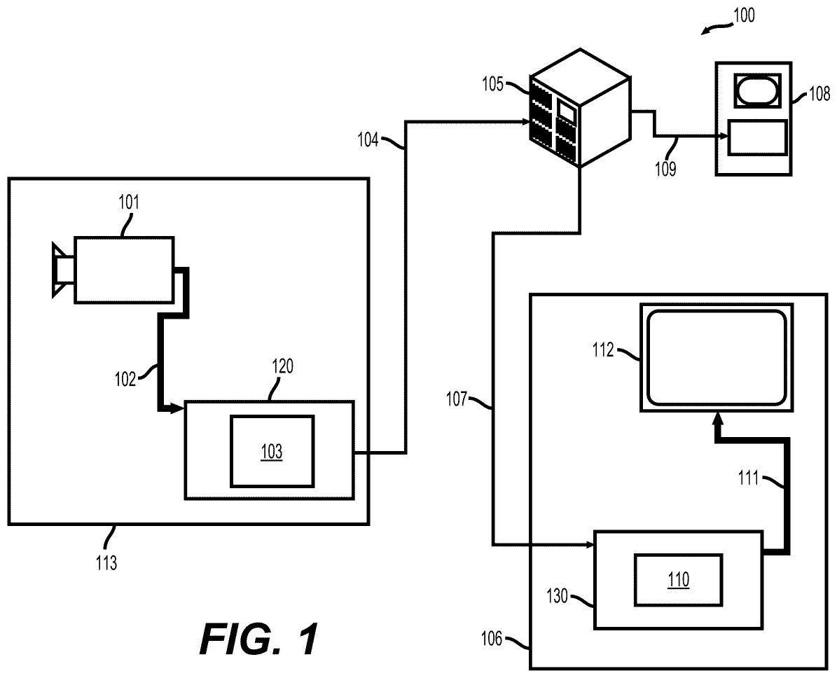

FIG. 1 shows a block diagram of a video processing system (100) in some examples. The video processing system (100) is an example of an application for the disclosed subject matter, a video encoder and a video decoder in a streaming environment. The disclosed subject matter can be equally applicable to other video enabled applications, including, for example, video conferencing, digital TV, streaming services, storing of compressed video on digital media including CD, DVD, memory stick and the like, and so on.

The video processing system (100) includes a capture subsystem (113), that can include a video source (101), for example a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), can be processed by an electronic device (120) that includes a video encoder (103) coupled to the video source (101). The video encoder (103) can include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), can be stored on a streaming server (105) for future use. One or more streaming client subsystems, such as client subsystems (106) and (108) in FIG. 1 can access the streaming server (105) to retrieve copies (107) and (109) of the encoded video data (104). A client subsystem (106) can include a video decoder (110), for example, in an electronic device (130). The video decoder (110) decodes the incoming copy (107) of the encoded video data and creates an outgoing stream of video pictures (111) that can be rendered on a display (112) (e.g., display screen) or other rendering device (not depicted). In some streaming systems, the encoded video data (104), (107), and (109) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) can include other components (not shown). For example, the electronic device (120) can include a video decoder (not shown) and the electronic device (130) can include a video encoder (not shown) as well.

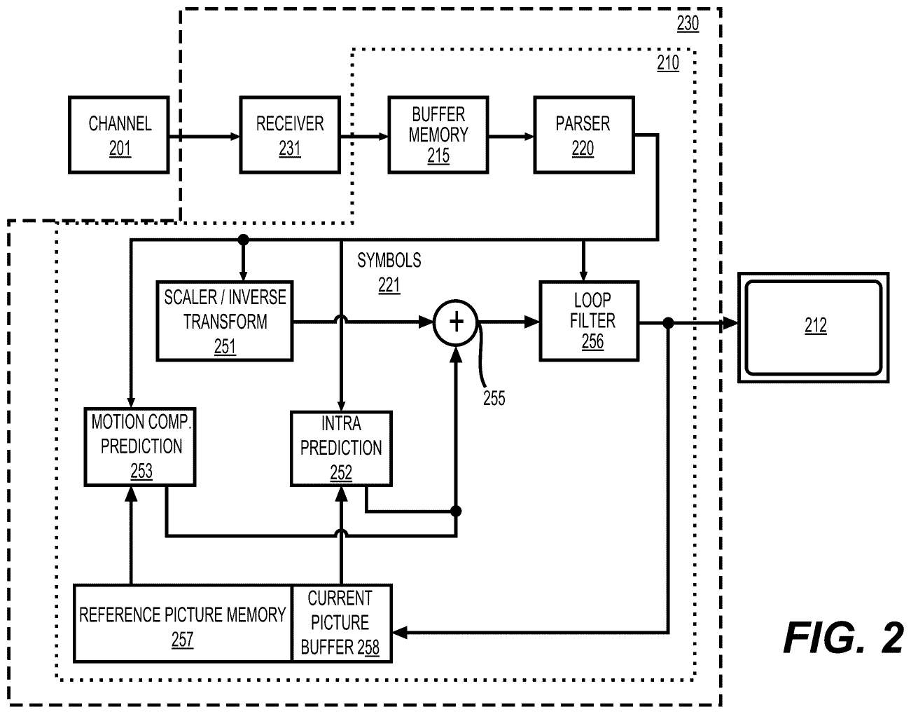

FIG. 2 shows an example of a block diagram of a video decoder (210). The video decoder (210) can be included in an electronic device (230). The electronic device (230) can include a receiver (231) (e.g., receiving circuitry). The video decoder (210) can be used in the place of the video decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values, that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

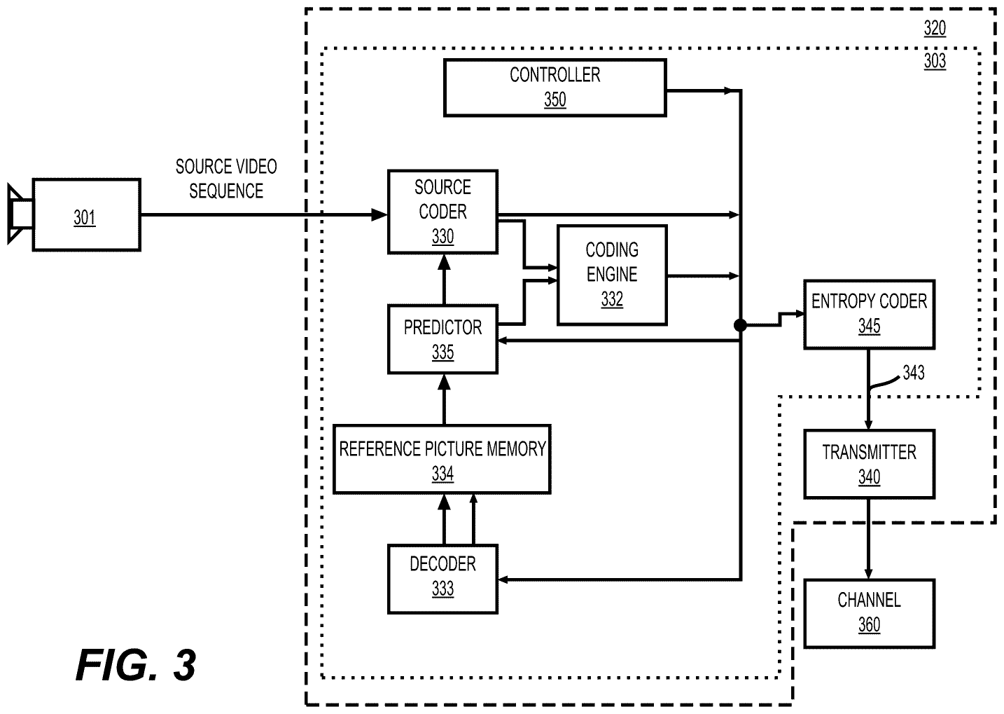

FIG. 3 shows an example of a block diagram of a video encoder (303). The video encoder (303) is included in an electronic device (320). The electronic device (320) includes a transmitter (340) (e.g., transmitting circuitry). The video encoder (303) can be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can include one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, . . . ), picture size, group of pictures (GOP) layout, maximum motion vector search range, and so forth. The controller (350) can be configured to have other suitable functions that pertain to the video encoder (303) optimized for a certain system design.

In some aspects, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may include temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes use of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some aspects, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some aspects of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) can be implemented using any suitable technique. In an aspect, the video encoders (103) and (303) and the video decoders (110) and (210) can be implemented using one or more integrated circuits. In another aspect, the video encoders (103) and (303), and the video decoders (110) and (210) can be implemented using one or more processors that execute software instructions.

In various examples, a current picture (also interchangeably referred to as a current frame) may be used as a reference area of block based compensation, such as in an intra block copy (IBC), an intra template matching prediction (IntraTMP) mode, or the like.

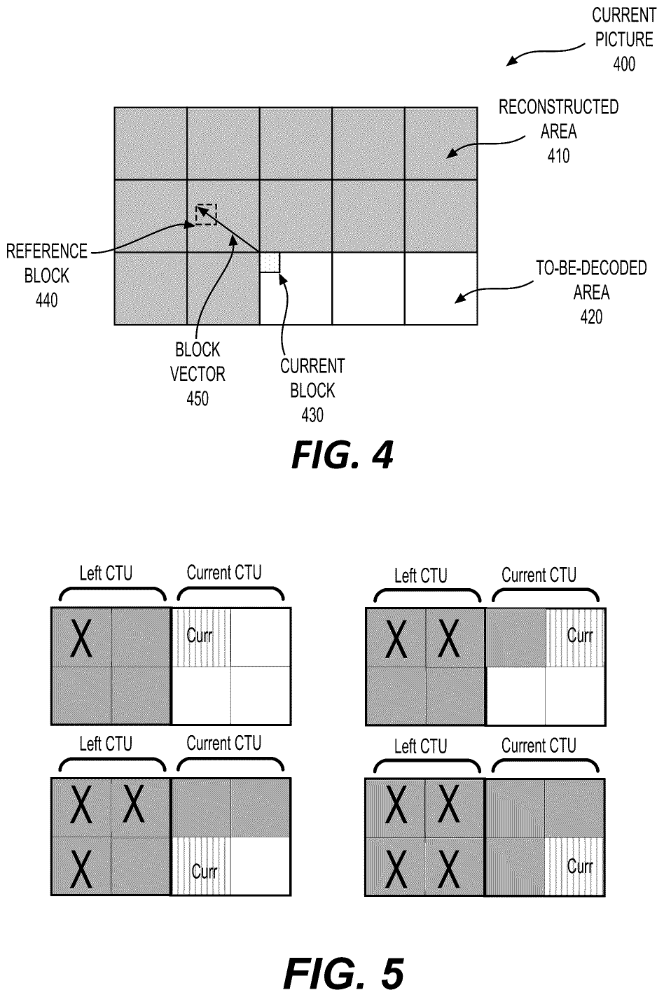

In an aspect, block based compensation from a different picture may be referred to as motion compensation. Similarly, a block compensation can be performed from a previously reconstructed area within the same picture, which may include intra picture block compensation (also referred to as current picture referencing (CPR) or the IBC mode). FIG. 4 shows an example of intra picture block compensation such as the IBC mode according to an aspect of the disclosure. A displacement vector that indicates an offset between a current block (430) and a reference block (440) may be referred as a block vector (BV) (450). The current block (430) and the reference block (440) are in a current picture (400).

Different from an MV in motion compensation, which can be at any value (positive or negative, at either x or y direction), a BV may have some constraints such that the pointed reference block is available and is already reconstructed. In an example, referring to FIG. 4, the current picture (400) may include a to-be-decoded area (420) and a reconstructed area (410). In an example, a BV may be constrained to point to a reference block in the reconstructed area (410). In some examples, for parallel processing consideration, some reference area that is tile boundary or wavefront ladder shape boundary may be excluded.

Block matching (BM) may be performed at the encoder to find an optimal BV for each CU. At the encoder side, hash-based motion estimation may be performed for the IBC mode. The encoder may perform a rate-distortion (RD) check for blocks with either width or height no larger than 16 luma samples. For a non-merge mode, the BV search may be performed using hash-based search first. If the hash-based search does not return a valid candidate, a block matching based local search may be performed.

In the hash-based search, hash key matching (32-bit cyclic redundancy check (CRC)) between a current block and a reference block may be extended to all allowed block sizes. The hash key calculation for every position in the current picture may be based on 4×4 subblocks. For the current block of a larger size, a hash key may be determined to match that of the reference block when all the hash keys of the respective 4×4 subblocks match the hash keys in the corresponding reference locations. If hash keys of multiple reference blocks are found to match those of the current block, the BV costs of each matched reference may be calculated and the one with the minimum cost is selected.

In the block matching search, the search range may be set to include both the previous CTU and the current CTU.

The coding of a BV may be either explicit or implicit. In the explicit mode, a difference between a BV and a BV predictor may be signaled. In the implicit mode, the BV may be recovered purely from the BV predictor, in a similar way as an MV in a merge mode. The resolution of a BV, in some implementations, may be restricted to integer positions; in other systems, the resolution of a BV may be allowed to point to fractional positions.

In an example, the intra block copy is treated as an inter mode (also interchangeably referred to as an inter prediction mode). By treating the intra block copy as an inter mode, the block vector prediction in the implicit mode and the explicit mode may be similar to the merge mode and the AMVP mode, respectively. In an example, the intra block copy is treated as a third mode, which is different from either the intra prediction mode or the inter prediction mode. By treating the intra block copy as the third mode, the block vector prediction in the implicit mode and the explicit mode may be separated from the regular inter mode. In an example, the explicit mode described above may be referred to as an IBC AMVP mode, and the implicit mode described above may be referred to as an IBC merge mode. For example, a separate merge candidate list is defined for the IBC mode (e.g., the IBC merge mode), where all the entries in the list are BVs, for example. Similarly, in an example, the block vector prediction list in the IBC AMVP mode only consists of BVs. In some examples, the general rules applied to both lists include: both lists may follow the same logic as the inter merge candidate list used in the inter mode or the AMVP predictor list used in the inter mode in terms of candidate derivation process. For example, the 5 spatial neighboring locations in inter merge mode such as HEVC or VVC inter merge mode may be accessed for the IBC mode to derive its own merge candidate list.

The use of intra block copy at a block level, can be signaled using a block level flag, refer as an IBC flag. In an aspect, the IBC flag is signaled when the current block is not coded in the merge mode. In an example, the IBC flag can be signaled by a reference index approach, for example, by treating the current decoded picture as a reference picture. In an example, such as in HEVC SCC, such a reference picture (e.g., the current decoded picture) is put in the last position of a list (e.g., a reference picture list). The special reference picture (e.g., the current decoded picture) may be managed together with other temporal reference pictures in a decoded picture buffer (DPB).

In an example, at a CU level, the IBC mode may be signalled with a flag and may be signaled as an IBC AMVP mode or an IBC skip/merge mode as follows:
The IBC skip/merge mode: a merge candidate index is used to indicate which of the BVs in the merge list from neighboring candidate IBC coded blocks is used to predict the current block. The merge list may include or consist of spatial, HMVP, and pairwise candidates.
The IBC AMVP mode: a BV difference is coded in the same way as an MV difference. The BV prediction method may use two candidates as predictors (e.g., BV predictors), one from a left neighbor (if the left neighbor is IBC coded) and one from an above neighbor (if the top neighbor is IBC coded). When either neighbor is not available, a default BV may be used as a predictor (e.g., a BV predictor). A flag is signaled to indicate the BV predictor index.

FIG. 5 shows an example of intra picture block compensation with one CTU size search range and in some examples reuse of the memory for searching some part of a left CTU according to an aspect of the disclosure.

In some examples, such as in VVC, the search range of the IBC mode is constrained to be within a current CTU. In an example, the effective memory requirement to store reference samples for the IBC mode is one CTU size of samples. Considering the existing reference sample memory to store reconstructed samples in a current 64×64 region, 3 more 64×64 sized reference sample memory may be used. Thus, a method may be used to extend the effective search range of the IBC mode to some part of a left CTU while the total memory requirement for storing reference pixels may be kept unchanged, e.g., the total memory requirement is 1 CTU size, such as 4 of 64×64 reference sample memory in total. FIG. 5 shows an example of such a memory reuse mechanism. Each vertical stripped block is a current coding region (Curr), samples in each grey area are coded samples, the cross out regions (marked with “X”) are not available for reference as the cross out regions may be replaced in the reference sample memory by the coding regions in a current CTU.

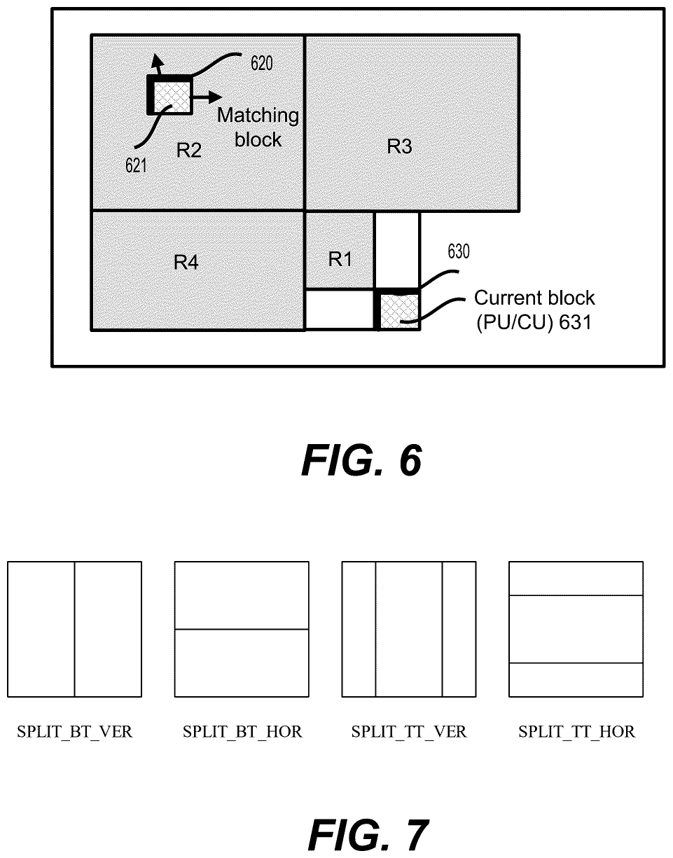

FIG. 6 shows an example of the IntraTMP mode according to an aspect of the disclosure. In an example, the IntraTMP mode is a special intra prediction mode. In an example, the IntraTMP mode is different from the intra prediction mode. Referring to FIG. 6, in an example of the IntraTMP mode, a prediction block (621) such as the best prediction block from a reconstructed part of a current frame may be copied. A template (620) such as an L-shaped template of the prediction block (621) may match a current template (630) of a current block (631). For a predefined search range, the encoder may search for the most similar template to the current template (630) in the reconstructed part of the current frame and may use the corresponding block (621) as a prediction block. In an example, the encoder then signals the usage of the IntraTMP mode, and the same prediction operation is performed at the decoder side.

Referring to FIG. 6, the prediction signal may be generated by matching the L-shaped causal neighbor of the current block (631) with another block in a predefined search area. In an example, the predefined search area includes or consists of: R1 that is a current CTU, R2 that is a top-left CTU of the current CTU, R3 that is an above CTU of the current CTU, and R4 that is a left CTU of the current CTU. In an example, a sum of absolute differences (SAD) is used as a cost function.

Within each region, the decoder may search for a template that has a least cost (e.g., a least SAD) with respect to the current template and may use a block corresponding to the least cost as a prediction block.

The dimensions of all regions (SearchRange_w, SearchRange_h) may be set to be proportional to a block dimension (BlkW, BlkH) to have a fixed number of SAD comparisons per pixel. In an example, SearchRange_w=a×BlkW, and SearchRange_h=a×BlkH, where ‘a’ is a constant that controls a trade-off between gain and complexity. In an example, ‘a’ is equal to 5.

To speed-up the template matching process, in some examples, the search range of all search regions is subsampled, for example, by a factor of 2, and thus leading to a reduction of template matching search by 4. After finding the best match, a refinement process may be performed. The refinement process may be performed via a second template matching search around the best match with a reduced range. In an example, the reduced range is defined as min (BlkW, BlkH)/2.

The Intra template matching tool may be enabled for CUs with a size less than or equal to 64 in width and height. The maximum CU size for the IntraTMP mode may be configurable. The IntraTMP mode may be signaled at a CU level through a dedicated flag, for example, when decoder-side intra mode derivation (DIMD) is not used for the current CU.

Various partitioning may be applied in video and/or imaging coding, such as in VVC. A picture may be partitioned into coding tree units (CTUs). For example, pictures are divided into a sequence of CTUs. The CTU concept in VVC may be the same as in HEVC. In some examples, for a picture that has three sample arrays, a CTU may include an N×N block of luma samples together with two corresponding blocks of chroma samples.

In an example, the maximum allowed size of the luma block in a CTU is specified to be 128×128. In an example, the maximum size of the luma transform blocks is 64×64.

A CTU may be partitioned using a tree structure. In some examples, such as in HEVC, a CTU is split into CUs by using a quaternary-tree (QT) structure denoted as coding tree to adapt to various local characteristics. The decision whether to code a picture area using inter-picture (temporal) or intra-picture (spatial) prediction may be made at the leaf CU level. Each leaf CU may be further split into one, two or four PUs according to the PU splitting type. Inside one PU, the same prediction process may be applied and the relevant information may be transmitted to the decoder on a PU basis. After obtaining the residual block by applying the prediction process based on the PU splitting type, a leaf CU can be partitioned into transform units (TUs) according to another quaternary-tree structure similar to the coding tree for the CU. In an example, the HEVC structure has the multiple partition conceptions including CU, PU, and TU.

In some examples, such as in VVC, a quadtree with nested multi-type tree (MTT) using binary and ternary splits segmentation structure may replace the concepts of multiple partition unit types, e.g., the separation of the CU, PU and TU concepts may be removed, for example, except for CUs that have a size too large for the maximum transform length, and supports more flexibility for CU partition shapes. In the coding tree structure, a CU can have any suitable shape, such as a square or rectangular shape. A CTU may be first partitioned by a quaternary tree (also referred to as quadtree) structure. Then the quaternary tree leaf nodes can be further partitioned by a multi-type tree structure. FIG. 7 shows an example of multi-type tree splitting modes according to an aspect of the disclosure. A multi-type tree structure may include four splitting types: vertical binary splitting (SPLIT_BT_VER), horizontal binary splitting (SPLIT_BT_HOR), vertical ternary splitting (SPLIT_TT_VER), and horizontal ternary splitting (SPLIT_TT_HOR). The multi-type tree leaf nodes may be referred to as coding units (CUs), and unless the CU is too large for the maximum transform length, this segmentation (e.g., the CU) may be used for prediction and transform processing without any further partitioning. Thus, in various examples, the CU, PU and TU have the same block size in the quadtree with nested multi-type tree coding block structure. The exception may occur, for example, when the maximum supported transform length is smaller than the width or height of the color component of the CU.

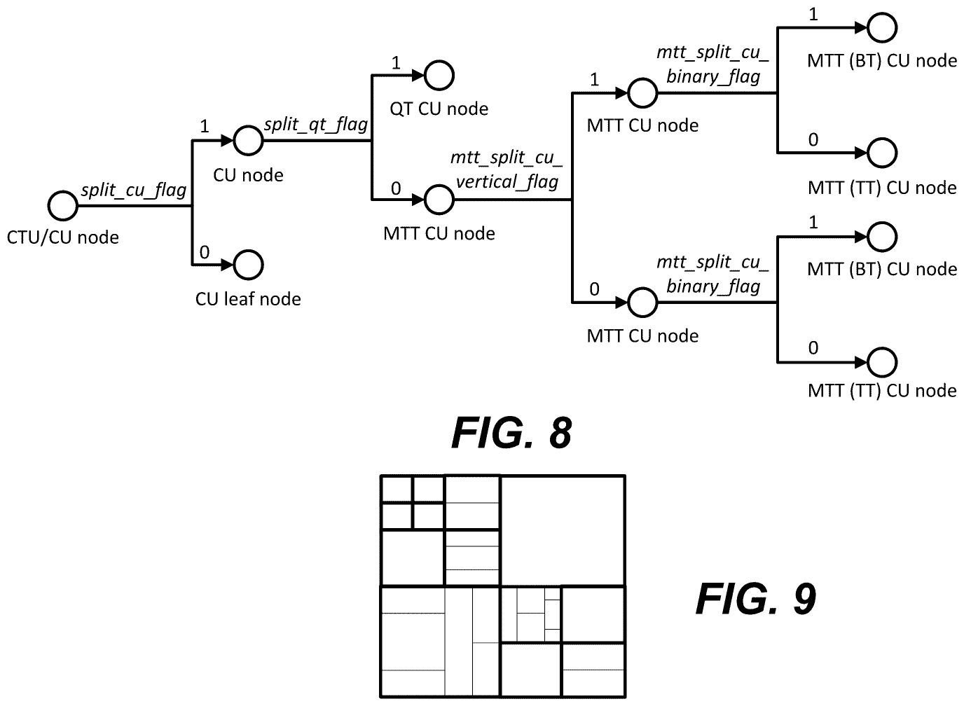

FIG. 8 shows an example of a signaling mechanism of the partition splitting information in a quadtree with nested multi-type tree coding tree structure according to an aspect of the disclosure. FIG. 8 shows examples of splitting flags signaling in quadtree with nested multi-type tree coding tree structure. A CTU may be treated as the root of a quaternary tree and may be first partitioned by a quaternary tree structure. Each quaternary tree leaf node (e.g., when sufficiently large to allow it) may be further partitioned by a multi-type tree structure. In the quadtree with nested multi-type tree coding tree structure, for each CU node, a first flag (split_cu_flag) may be signaled to indicate whether the node is further partitioned. In an example, if the current CU node is a quadtree CU node, a second flag (split_qt_flag) may be signaled to indicate whether the current CU node is further partitioned using a QT partitioning or MTT partitioning mode. When a node (e.g., the current CU node) is partitioned with MTT partitioning mode, a third flag (e.g., mtt_split_cu_vertical_flag) may be signaled to indicate the splitting direction, and then a fourth flag (e.g., mtt_split_cu_binary_flag) may be signaled to indicate whether the split is a binary split or a ternary split. Based on the values of mtt_split_cu_vertical_flag and mtt_split_cu_binary_flag, the multi-type tree slitting mode (MttSplitMode) of a CU may be derived as shown in Table 1.

TABLE 1
Multi-type tree slitting mode (MttSplitMode) derivation
based on multi-type tree syntax elements

| | mtt_split_cu_ver- | |
|---|---|---|
| MttSplitMode | tical_flag | mtt_split_cu_binary_flag |
| SPLIT_TT_HOR | 0 | 0 |
| SPLIT_BT_HOR | 0 | 1 |
| SPLIT_TT_VER | 1 | 0 |
| SPLIT_BT_VER | 1 | 1 |

FIG. 9 shows an example of a CTU divided into multiple CUs with a quadtree and nested multi-type tree coding block structure according to an aspect of the disclosure. Referring to FIG. 9, the bold block edges represent quadtree partitioning and the remaining edges represent multi-type tree partitioning. The quadtree with nested multi-type tree partition may provide a content-adaptive coding tree structure including CUs. In an example, the size of the CU may be as large as the CTU or as small as 4×4 in units of luma samples. In an example, for the 4:2:0 chroma format, the maximum chroma CB size is 64×64 and the minimum size chroma CB consists of 16 chroma samples.

In an example, the maximum supported luma transform size may be 64×64 and the maximum supported chroma transform size may be 32×32. When the width or height of the CB is larger than the maximum transform width or height, the CB may be automatically split in the horizontal and/or vertical direction to meet the transform size restriction in the respective direction.

A coding tree scheme may support the ability for the luma and chroma to have a same block tree structure or separate block tree structures. For P and B slices, in some examples, luma and chroma CTBs in a CTU may share the same coding tree structure. A coding tree type can be a dual-tree type (also referred to as a chroma separate tree, such as DUAL_TREE_CHORMA), such as used in VVC, and luma and chroma CTBs in a CTU may have separate block tree structures. For I slices, in some examples, luma and chroma CTBs in a CTU may have separate block tree structures. When the separate block tree mode is applied, a luma CTB may be partitioned into CUs (e.g., luma CBs) by one coding tree structure, and the chroma CTBs may be partitioned into chroma CUs (e.g., chroma CBs) by another coding tree structure. Thus, a CU in a I slice may include, or consist of, a coding block of the luma component or coding blocks of two chroma components, and a CU in a P or B slice includes, or consists of, coding blocks of all three color components unless the video is monochrome.

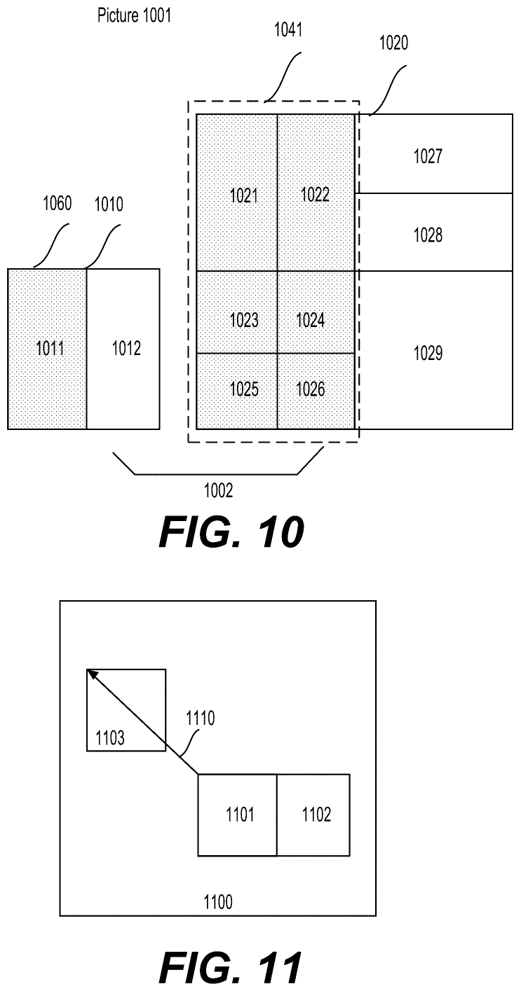

FIG. 10 shows an example of separate partitioning structures of a luma CTB (1020) and a chroma CTB (1010) in a CTU (1002) according to an aspect of the disclosure. The CTU (1002) is in a picture (1001).

The chroma CTB (1010) may be collocated with the luma CTB (1020), for example, the chroma CTB (1010) and the luma CTB (1020) correspond to the same physical region (1002) in the picture (1001). Dimensions (e.g., a width and/or a height) of the chroma CTB (1010) and the luma CTB (1020) can be indicated by a chroma subsampling format (also referred to as a sampling format) such as 4:2:0, 4:2:2, and the like. In the example shown in FIG. 10, the chroma format sampling structure is 4:2:0, a width and a height of the chroma CTB (1010) are ½ of a width and a height of the luma CTB (1020), respectively.

For the chroma separate tree, the luma CTB (1020) and the chroma CTB (1010) in the CTU (1002) can be partitioned using two separate coding tree structures. In an example, the picture (1001) is an intra picture (I picture). The luma CTB (1020) and the chroma CTB (1010) can be partitioned using separate intra luma/chroma coding tree structures.

The luma CTB (1020) can be partitioned using any suitable coding tree structure. The chroma CTB (1010) can be partitioned using any suitable coding tree structure. In the example shown in FIG. 10, the chroma CTB (1010) is partitioned into chroma blocks (1011)-(1012), for example, by a binary tree. In the example shown in FIG. 10, the luma CTB (1020) is partitioned into luma blocks (1021)-(1029), for example, by quad-tree split(s), binary tree, and/or the like. For example, the luma CTB (1020) is partitioned into 4 blocks using a quad-tree split. A top-left block of the luma CTB (1020) is further partitioned into the luma blocks (1021)-(1022) using a binary tree. A top-right block of the luma CTB is further partitioned into the luma blocks (1027)-(1028) using a binary tree. A bottom-left block of the luma CTB (1020) is further partitioned into the luma blocks (1023)-(1026) using a quad-tree split. A bottom-right block of the luma CTB (1020) is not partitioned and is the luma block (1029).

When the chroma separate tree (CST) is used, the current chroma block (1011) can be collocated with one or more luma blocks in the luma CTB (1020). A number of the luma block(s) collocated with the current chroma block (1011) can depend on the coding tree structures used to partition the CTU (1002). Referring to FIG. 10, the current chroma block (1011) can be collocated with the luma blocks (1021)-(1026).

Aspects of the disclosure provide techniques, apparatuses, and methods related to block partitioning such as coding tree block (CTB) partitioning.

Partitioning decisions (also referred to as partitioning structures or partition decisions) of a CTB may include decisions associated with how to partition the CTB, as illustrated in FIG. 8 for example. A CTB in the disclosure may refer to a CTB or a variant such as a superblock where a tree structure may be applied to partition the CTB. The partitioning decisions of the CTB may be indicated by syntax elements. For example, the syntax elements include control flags such as splitting flags (e.g., split_cu_flag, split_qt_flag, mtt_split_cu_vertical_flag, and the like) shown in FIG. 8. Applying the partitioning decisions (or the partitioning structures) to the CTB may partition the CTB into coding blocks, such as shown in FIG. 9.

Partitioning decisions for a current CTB may be closely related to partitioning structures of other CTBs, such as neighboring CTBs. The correlation between the partitioning structures of the current CTB and neighboring CTBs may be exploited in entropy coding the control flags (e.g., split_cu_flag, split_qt_flag, and the like shown in FIG. 8) corresponding to partitioning decisions (or partition structures) of the current CTB. Contexts in the entropy coding may be modeled based on previously coded partitioning decisions of neighboring CTBs of the current CTB in a current picture (also referred to as a current frame). The neighboring CTBs and the current CTB are in the same current picture.

For inter coded pictures (also referred to as frames) or slices, the spatial correlation between the partitioning structures of the current CTB and the neighboring CTBs of the current CTB may extend to the partitioning structures of a reference picture (also referred to as a reference frame). The disclosure includes a set of methods for exploiting a temporal correlation for improving coding efficiency.

In an aspect, the partitioning structures of the current CTB may be related to partitioning structures of spatially neighboring CTB(s) of the current CTB, CTB(s) (also referred to as remote spatial neighbor(s)) that are in the current picture and are not adjacent to the current CTB, and/or temporal neighboring CTB(s) of the current CTB. Thus, according to an aspect of the disclosure, the correlation of the partitioning structures may include a spatial correlation and/or a temporal correlation. In an example, a displacement between a remote spatial neighbor and the current block that are in the current picture may be indicated by a vector such as a block vector (BV). In an example, a temporal neighboring CTB in a reference picture may be indicated by an MV.

In an aspect, a set S of partition decisions of the current CTB may be determined. In an example, a first partitioning method may be applied to determine (e.g., derive) the set S of partition decisions of the current CTB. The first partitioning method may be any suitable partitioning method that may partition the current CTB into blocks. For example, the first partitioning method includes a recursive quadtree partitioning, a recursive multi-type tree partitioning, a recursive quadtree partitioning with a nested recursive multi-type tree partitioning, or the like. In an example, the set S may include all possible partition decisions for the current CTB. For example, certain restrictions may be applied to partition decisions of the current CTB at the encoder side and/or the decoder side, and the set S of partition decisions of the current CTB may include all possible partition decisions except those that fall within the certain restrictions. In an example, not all partition decisions in the set S of partition decisions are allowed for the current CTB. A second partitioning method may be applied to prune out some partitions in the set S, for example, the second partitioning method may be designed to further determine a subset Sₖ of partition decisions from the set S of partition decisions of the current CTB. The subset Sₖ of partition decisions may include allowable partition decisions for the current CTB. The subset Sₖ of allowable partition decisions may include at least one element (e.g., a partition decision) in the set S. In an example, the first partitioning method and the second partitioning method are performed by the encoder and the decoder. In an example, the second partitioning method is applied at the decoder without signaling. In an example, a syntax element may be signaled at a picture level (or a frame level) to indicate whether the second partitioning method is applied at the decoder.

According to an aspect of the disclosure, a first region of interest (ROI) in a first reference picture of the current CTB may be determined. The current CTB is in the current picture. A subset Sₖ of allowable partition decisions may be determined from a set S of partition decisions of the current CTB based at least on first partitioning structures of the first ROI in the first reference picture. The current CTB may be partitioned based on the subset Sₖ of allowable partition decisions. In an example, the set S of partition decisions of the current CTB is determined using the first partitioning method, such as any suitable partitioning method. The subset Sₖ of allowable partition decisions may be determined using the second partitioning method. Various examples of the second partitioning method are described in the disclosure.

In an aspect, the first ROI in the first reference picture may be indicated by one of an MV and a BV of a previously coded (e.g., reconstructed) neighboring CTB of the current CTB. The previously coded (e.g., reconstructed) neighboring CTB may be in the current picture.

In an aspect, for the current CTB that is in an inter coded slice or an inter coded picture (or an inter coded frame), the second partitioning method may determine (or derive) the subset Sₖ of allowable partition decisions of the current CTB by utilizing information regarding the partitioning structures of reference picture(s) (or reference frame(s)). The reference frame(s) may include the first reference picture. The partitioning structures of the reference frame(s) may include partitioning structures of a region in the first reference picture, such as first partitioning structures of the first ROI in the first reference picture. In an example, the current picture may be an inter picture, a reference picture list (also referred to as a reference frame list) including previously decoded pictures or frames may be determined for the current picture. The reference frame(s) including the first reference picture may be determined from the reference picture list.

In an aspect, MV(s) or BV(s) from previously coded neighboring CTB(s) in the current picture may be utilized to identify ROI(s) in the reference frame(s). The previously coded neighboring CTB(s) may be neighbors of the current CTB. The MV(s) or the BV(s) may indicate the respective ROI(s) in the reference frame(s). The partitioning structures from the ROI(s) may be used by the second portioning method to derive the Sₖ for the current CTB. In an example, the previously coded neighboring CTB(s) include the previously coded neighboring CTB described above, and the ROI(s) may include the first ROI in the first reference picture that is indicated by the one of the MV and the BV of the previously coded neighboring CTB.

In an aspect, the first reference picture is the current picture, and the first ROI is in the current picture. For example, one of the reference frame(s) may be the current picture, e.g., the current picture that is being encoded at the encoder side or being reconstructed at the decoder side, and an ROI region in the one of the reference frame(s) is located within the current picture.

In an aspect, the ROI(s) including the first ROI may take the maximum allowable block size or smaller. In an example, the size of the ROI(s) including the first ROI may be less than or equal to the maximum allowable block size.

In an aspect, a zero-motion vector may be used to indicate (e.g., identify) the first ROI, and the first reference picture is different from the current picture. A collocated region in the first reference picture (e.g., one of the reference frame(s)) that is centered with respect to the current CTB is the first ROI, for example, the first ROI is collocated with the current CTB.

In an aspect, when the reference frame(s) include multiple reference pictures and the multiple reference pictures are involved, the ROIs in all or at least one of the reference frame(s) may be used by the second partitioning method to derive the subset Sₖ of allowable partition decisions. For example, the multiple reference pictures of the current CTB include the first reference picture and a second reference picture. The subset Sₖ of allowable partition decisions may be determined from the set S of partition decisions of the current CTB based on at least (i) the first partitioning structures of the first ROI in the first reference picture and (ii) second partitioning structures of a second ROI in the second reference picture of the current CTB.

In an aspect, when the multiple reference pictures are involved, the second partitioning method may derive the subset Sₖ from the ROIs indicated (e.g., identified) by respective MVs. In an example, the MVs may be scaled based on a temporal distance of each reference picture and a target reference picture where each ROI is to be applied. The ROIs in the multiple reference pictures may be determined by the scaled MVs, respectively.

For example, the first ROI in the first reference picture is indicated by the MV of the previously coded (e.g., reconstructed) neighboring CTB. The first reference picture of the current CTB is different from a reference picture of the previously coded neighboring CTB. The MV indicating the first ROI may be scaled based on a temporal distance associated with the first reference picture and a temporal distance associated with the reference picture of the previously coded neighboring CTB. In an example, the temporal distance associated with the first reference picture is based on a picture order count (POC) of the current picture and a POC of the first reference picture. In an example, the temporal distance associated with the reference picture of the previously coded neighboring CTB is based on the POC of the current picture and a POC of the reference picture of the previously coded neighboring CTB. The first ROI in the first reference picture may be determined based on the scaled MV.

A quality of a picture may be assessed subjectively (e.g., assessed visually or via visual experiences) and/or objectively. The objective assessment may include predicting perceived visual quality using computational models, such as a peak signal-to-noise ratio (PSNR). In an aspect, a quantization parameter (QP) such as a frame level QP (also referred to a picture level QP) or a slice level QP may be used as an indicator of quality. A picture with a higher QP may have a lower quality. In some examples, pictures at different layers (e.g., hierarchical or temporal layers) may be coded with different QPs.

In an aspect, only the reference frame(s) coded at similar or better quality is used as the reference frame(s). In an example, a picture level QP associated with the first reference picture satisfies a pre-defined condition. For example, the reference frame(s) that are used in the second partitioning method are coded at a lower QP than the current picture, and the first reference picture included in the reference frame(s) is coded at a lower QP than the current picture.

In an aspect, when the reference frame is coded with a dual tree partitioning (or the chroma separate tree), such as described in FIG. 10, only the partitioning structures of a luma tree is used from the ROI by the second partitioning method to derive the subset Sₖ. In an example, the dual tree partitioning is applied to the first reference picture. The first partitioning structures of the first ROI include luma partitioning structures of a luma component in the first ROI. Referring to FIG. 10, the first ROI may include the CTU (1002). The luma component in the first ROI may refer to the luma CTB (1020). The luma partitioning structures of the first ROI (e.g., the luma CTB (1020) as shown in FIG. 10) may be used to determine the subset Sₖ of allowable partition decisions from the set of partition decisions of the current CTB. In an example, chroma partitioning structures of a chroma component (e.g., the chroma CTB (1010) in the first ROI are not used in determining the subset Sₖ.

In an aspect, when the reference frame (e.g., the first reference picture) is coded with the dual tree partitioning, the partitioning structures of both the luma tree and the chroma tree are considered from the ROI (e.g., the first ROI) by the second partitioning method to derive the subset Sₖ. In an example, the first partitioning structures of the first ROI include the luma partitioning structures of the luma component in the first ROI and the chroma partitioning structures of the chroma component in the first ROI. The subset Sₖ of allowable partition decisions may be determined from the set S of partition decisions of the current CTB based on the luma partitioning structures and the chroma partitioning structures of the first ROI. Referring to FIG. 10, the first ROI may be the CTU (1002), the luma component in the first ROI is the luma CTB (1020), and the chroma component in the first ROI is the chroma CTB (1010), and the subset Sₖ may be determined from the set S based on the luma partitioning structures of the luma CTB (1020) and the chroma partitioning structures of the chroma CTB (1010).

In an aspect, a look up table (LUT) may be used by the reference frames including the first reference picture to store the partition decisions. The granularity for the LUT may correspond to the maximum allowable block size or smaller. In an example, the partition decisions (or the partitioning structures) of each region in the first reference picture are stored in the LUT. A size of each region may be less than or equal to the maximum allowable block size. The first partitioning structures of the first ROI may be obtained from the LUT to determine the subset Sₖ.

In an aspect, residuals (or signaled coefficients) associated with the reference frame(s) including the first reference picture are used together with the ROI(s) by the second partitioning method to derive the subset Sₖ. In an example, the subset Sₖ of allowable partition decisions is determined from the set S of partition decisions of the current CTB based on the first partitioning structures of the first ROI in the first reference picture and the residuals (or the signaled coefficients) associated with the first reference picture.

In an aspect, the QP(s) associated with the reference picture(s) and/or the QP associated with the current picture are used together with the ROI(s) by the second partitioning method to derive the subset Sₖ. In an example, the reference picture(s) includes the first reference picture, the subset Sₖ of allowable partition decisions may be determined from the set S of partition decisions of the current CTB based on the first partitioning structures of the first ROI in the first reference picture and at least one of (i) the QP associated with the first reference picture and the QP associated with the current picture.

In an aspect, the temporal distance(s) between the reference picture(s) and the current picture may be used together with the ROI(s) by the second partitioning method to derive the subset Sₖ. In an example, the reference picture(s) includes the first reference picture, the subset Sₖ of allowable partition decisions may be determined from the set S of partition decisions of the current CTB based on the first partitioning structures of the first ROI in the first reference picture and the temporal distance between the first reference picture and the current picture.

In an aspect, temporal layer information of the reference picture(s) and the current picture may be used by the second partitioning method to derive the subset Sₖ. In an example, the temporal layer information of the reference picture(s) may be correlated with the QP(s) of the reference picture(s).

In an aspect, for the current CTB in an intra coded slice or an intra coded frame, the second partitioning method may derive the subset Sₖ by utilizing information associated with the partitioning structures from previously coded CTB(s) in the same current slice or in the same current picture. FIG. 11 shows an example of the first ROI in the current picture (1100) that is indicated by the BV (1110) of the previously coded (e.g., reconstructed) neighboring CTB (1101) of the current CTB (1102). For example, the current picture (1100) is an intra coded picture, the first reference picture is the current picture (1100), and the first ROI (e.g., the previously coded CTB) (1103) in the current picture (1100) may be indicated by the BV (1110) of the previously coded neighboring CTB (1101) of the current CTB (1102). The subset Sₖ may be determined from the set S based on the partitioning structures from the first ROI (e.g., the previously coded CTB) (1103) that is indicated by the BV (1110) of the previously coded neighboring CTB (1101) of the current CTB (1102).

In an aspect, the partitioning structures from the ROI(s) identified, for example as described above, may be used to model the contexts for entropy coding the control flags related to partition decisions of the current CTB. In an example, the contexts for entropy coding (e.g., encoding at the encoder side and decoding at the decoder side) the control flags associated with respective partition decisions of the current CTB may be determined based at least on the first partitioning structures of the first ROI, and the partition decisions of the current CTB, for example, included in the subset Sₖ may be determined based on the control flags.

The methods, aspects, and examples described in the disclosure may be used separately or combined in any order. The methods, aspects, and examples may be implemented by processing circuitry (e.g., one or more processors or one or more integrated circuits). In one example, the one or more processors execute a program that is stored in a non-transitory computer-readable medium.

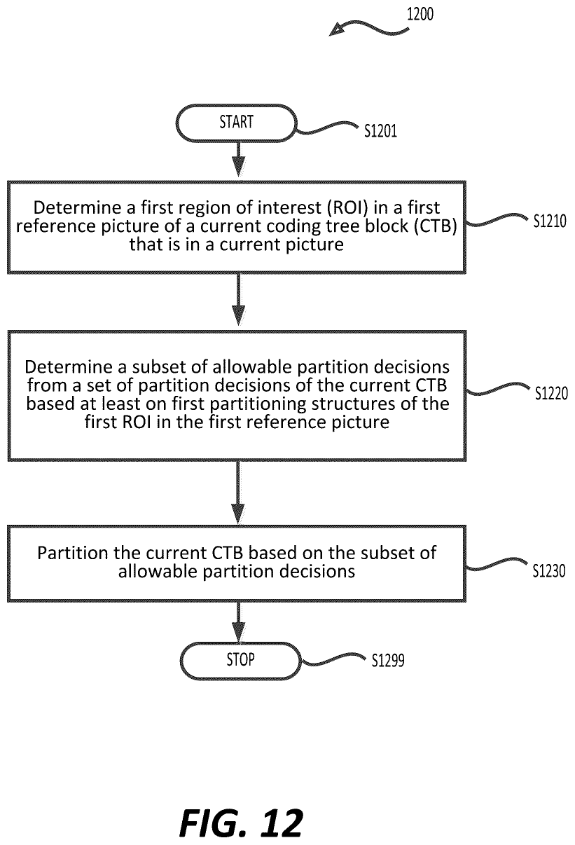

FIG. 12 shows a flow chart outlining a process (1200) according to an aspect of the disclosure. The process (1200) can be used in an apparatus, such as a video decoder. In various aspects, the process (1200) is executed by processing circuitry, such as the processing circuitry that performs functions of the video decoder (110), the processing circuitry that performs functions of the video decoder (210), and the like. In some aspects, the process (1200) is implemented in software instructions, thus when the processing circuitry executes the software instructions, the processing circuitry performs the process (1200). The process starts at (S1201) and proceeds to (S1210).

At (S1210), a first region of interest (ROI) in a first reference picture of a current coding tree block (CTB) is determined. The current CTB is in a current picture.

In an aspect, the first ROI in the first reference picture is indicated by one of an MV and a BV of a previously reconstructed neighboring CTB of the current CTB. The previously reconstructed neighboring CTB is in the current picture.

In an aspect, the first reference picture is the current picture.

In an aspect, the one of the MV and the BV is the MV, and the first reference picture is different from the current picture.

In an aspect, a picture level quantization parameter (QP) associated with the first reference picture satisfies a pre-defined condition.

In an example, the current picture is an inter coded picture.

In an example, the current picture is an intra coded picture.

At (S1220), a subset Sₖ of allowable partition decisions may be determined from a set S of partition decisions of the current CTB based at least on first partitioning structures of the first ROI in the first reference picture.

In an aspect, the subset of allowable partition decisions may be determined from the set of partition decisions of the current CTB based on at least (i) the first partitioning structures of the first ROI in the first reference picture and (ii) second partitioning structures of a second ROI in a second reference picture of the current CTB.

In an aspect, the one of the MV and the BV is the MV, the first reference picture of the current CTB is different from a reference picture of the previously reconstructed neighboring CTB, and the MV may be scaled based on a temporal distance associated with the first reference picture and a temporal distance associated with the reference picture of the previously coded neighboring CTB.

In an aspect, a dual tree partitioning is applied to the first reference picture. The first partitioning structures of the first ROI include luma partitioning structures of a luma component in the first ROI. The subset of allowable partition decisions may be determined from the set of partition decisions of the current CTB based on the luma partitioning structures of the first ROI.

In an aspect, the first partitioning structures of the first ROI include luma partitioning structures of a luma component in the first ROI and chroma partitioning structures of a chroma component in the first ROI. The subset of allowable partition decisions may be determined from the set of partition decisions of the current CTB based on the luma partitioning structures and the chroma partitioning structures of the first ROI.

In an example, partitioning structures of each region in the first reference picture are stored in a look up table (LUT). A size of each region is less than or equal to a maximum allowable block size. The first partitioning structures of the first ROI may be obtained from the LUT.

In an example, the subset of allowable partition decisions is determined from the set of partition decisions of the current CTB based on the first partitioning structures of the first ROI in the first reference picture and residuals associated with the first reference picture.

In an example, the subset of allowable partition decisions is determined from the set of partition decisions of the current CTB based on the first partitioning structures of the first ROI in the first reference picture and at least one of (i) a QP associated with the first reference picture and a QP associated with the current picture.

In an example, the subset of allowable partition decisions is determined from the set of partition decisions of the current CTB based on the first partitioning structures of the first ROI in the first reference picture and a temporal distance between the first reference picture and the current picture.

At (S1230), the current CTB is partitioned based on the subset of allowable partition decisions.

Then, the process proceeds to (S1299) and terminates.

The process (1200) can be suitably adapted. Step(s) in the process (1200) can be modified and/or omitted. Additional step(s) can be added. Any suitable order of implementation can be used.

In an aspect, contexts for entropy decoding control flags associated with respective partition decisions of the current CTB may be determined based at least on the first partitioning structures of the first ROI. Partition decisions of the current CTB may be determined based on the control flags.

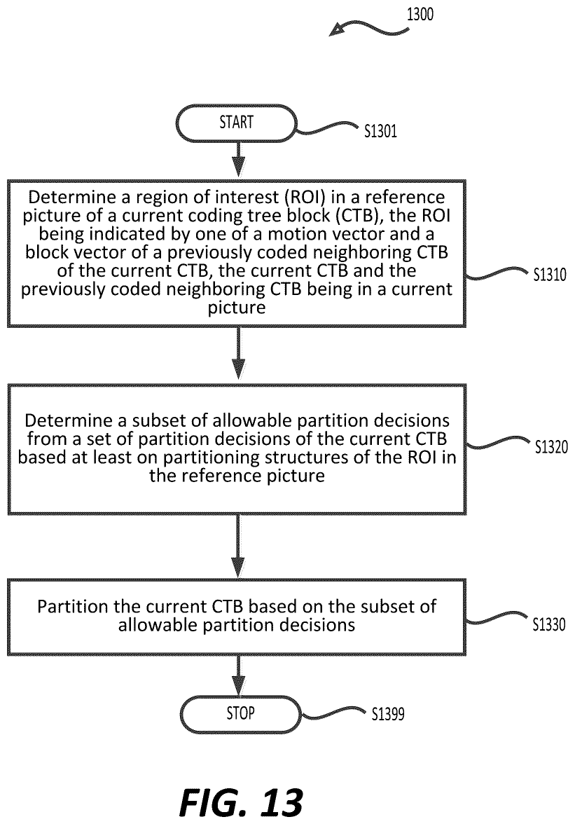

FIG. 13 shows a flow chart outlining a process (1300) according to an aspect of the disclosure. The process (1300) can be used in a video encoder. In various aspects, the process (1300) is executed by processing circuitry, such as the processing circuitry that performs functions of the video encoder (103), the processing circuitry that performs functions of the video encoder (303), and the like. In some aspects, the process (1300) is implemented in software instructions, thus when the processing circuitry executes the software instructions, the processing circuitry performs the process (1300). The process starts at (S1301) and proceeds to (S1310).

At (S1310), a region of interest (ROI) in a reference picture of a current coding tree block (CTB) may be determined. The ROI may be indicated by one of a motion vector and a block vector of a previously coded neighboring CTB of the current CTB. The current CTB and the previously coded neighboring CTB are in a current picture.

At (S1320), a subset of allowable partition decisions may be determined from a set of partition decisions of the current CTB based at least on partitioning structures of the ROI in the reference picture.

At (S1330), the current CTB may be partitioned based on the subset of allowable partition decisions.

Then, the process proceeds to (S1399) and terminates.

The process (1300) can be suitably adapted. Step(s) in the process (1300) can be modified and/or omitted. Additional step(s) can be added. Any suitable order of implementation can be used.

In an example, the one of the motion vector and the block vector is the motion vector, and the reference picture is different from the current picture.

In an aspect, a method of processing visual media data includes processing a bitstream of visual media data according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

The bitstream includes coded information indicating that a current coding tree block (CTB) in a current picture is partitioned based on a reference picture different from the current picture. The format rule may specify that a region of interest (ROI) in the reference picture of the current CTB is determined, the ROI is indicated by a motion vector of a previously coded neighboring CTB of the current CTB, and the previously coded neighboring CTB is in the current picture. The format rule may specify that a subset of allowable partition decisions is determined from a set of partition decisions of the current CTB based at least on partitioning structures of the ROI in the reference picture and the current CTB is partitioned based on the subset of allowable partition decisions.

In an example, the format rule specifies that the reference picture of the current CTB is different from a reference picture of the previously coded neighboring CTB, and the motion vector is scaled based on a temporal distance of the reference picture and a temporal distance of the reference picture of the previously coded neighboring CTB.

Aspects and/or examples in the disclosure may be used separately or combined in any order. For example, some aspects and/or examples performed by the decoder may be performed by the encoder and vice versa. Each of the methods (or aspects), an encoder, and a decoder may be implemented by processing circuitry (e.g., one or more processors or one or more integrated circuits). In one example, the one or more processors execute a program that is stored in a non-transitory computer-readable medium.

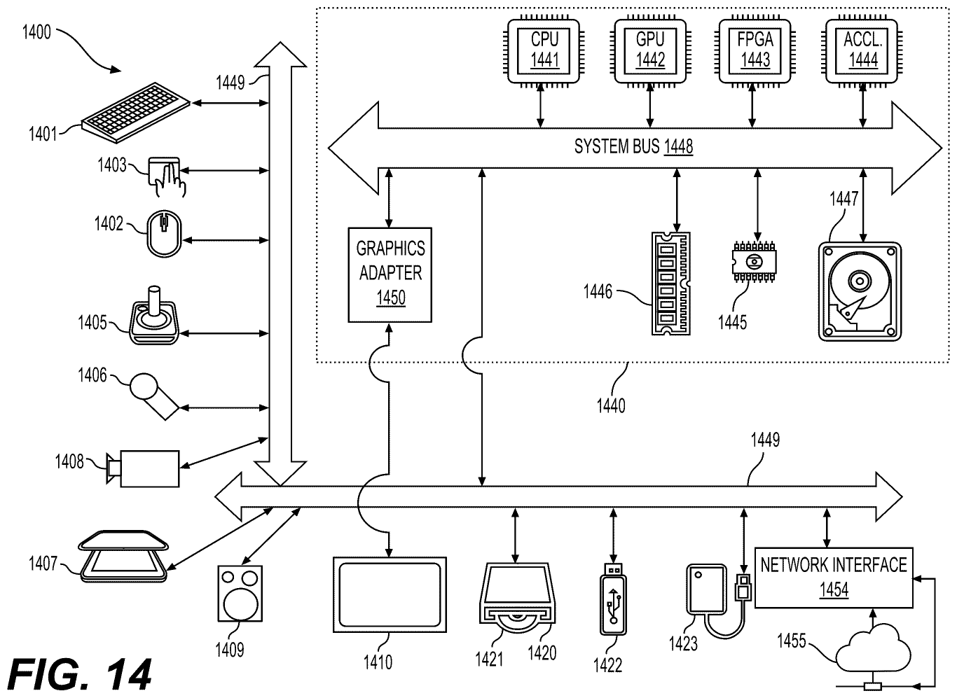

The techniques described above, can be implemented as computer software using computer-readable instructions and physically stored in one or more computer-readable media. For example, FIG. 14 shows a computer system (1400) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 14 for computer system (1400) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of a computer system (1400).

Computer system (1400) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (1401), mouse (1402), trackpad (1403), touch screen (1410), data-glove (not shown), joystick (1405), microphone (1406), scanner (1407), camera (1408).

Computer system (1400) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (1410), data-glove (not shown), or joystick (1405), but there can also be tactile feedback devices that do not serve as input devices), audio output devices (such as: speakers (1409), headphones (not depicted)), visual output devices (such as screens (1410) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (1400) can also include human accessible storage devices and their associated media such as optical media including CD/DVD ROM/RW (1420) with CD/DVD or the like media (1421), thumb-drive (1422), removable hard drive or solid state drive (1423), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (1400) can also include an interface (1454) to one or more communication networks (1455). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (1449) (such as, for example USB ports of the computer system (1400)); others are commonly integrated into the core of the computer system (1400) by attachment to a system bus as described below (for example Ethernet interface into a PC computer system or cellular network interface into a smartphone computer system). Using any of these networks, computer system (1400) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (1440) of the computer system (1400).

The core (1440) can include one or more Central Processing Units (CPU) (1441), Graphics Processing Units (GPU) (1442), specialized programmable processing units in the form of Field Programmable Gate Areas (FPGA) (1443), hardware accelerators for certain tasks (1444), graphics adapters (1450), and so forth. These devices, along with Read-only memory (ROM) (1445), Random-access memory (1446), internal mass storage such as internal non-user accessible hard drives, SSDs, and the like (1447), may be connected through a system bus (1448). In some computer systems, the system bus (1448) can be accessible in the form of one or more physical plugs to enable extensions by additional CPUs, GPU, and the like. The peripheral devices can be attached either directly to the core's system bus (1448), or through a peripheral bus (1449). In an example, the screen (1410) can be connected to the graphics adapter (1450). Architectures for a peripheral bus include PCI, USB, and the like.

CPUs (1441), GPUs (1442), FPGAs (1443), and accelerators (1444) can execute certain instructions that, in combination, can make up the aforementioned computer code. That computer code can be stored in ROM (1445) or RAM (1446). Transitional data can also be stored in RAM (1446), whereas permanent data can be stored for example, in the internal mass storage (1447). Fast storage and retrieve to any of the memory devices can be enabled through the use of cache memory, that can be closely associated with one or more CPU (1441), GPU (1442), mass storage (1447), ROM (1445), RAM (1446), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (1400), and specifically the core (1440) can provide functionality as a result of processor(s) (including CPU, GPUs, FPGA, accelerators, and the like) executing software embodied in one or more tangible, computer-readable media. Such computer-readable media can be media associated with user-accessible mass storage as introduced above, as well as certain storage of the core (1440) that are of non-transitory nature, such as core-internal mass storage (1447) or ROM (1445). The software implementing various aspects of the present disclosure can be stored in such devices and executed by core (1440). A computer-readable medium can include one or more memory devices or chips, according to particular needs. The software can cause the core (1440) and specifically the processors therein (including CPU, GPU, FPGA, and the like) to execute particular processes or particular parts of particular processes described herein, including defining data structures stored in RAM (1446) and modifying such data structures according to the processes defined by the software. In addition or as an alternative, the computer system can provide functionality as a result of logic hardwired or otherwise embodied in a circuit (for example: accelerator (1444)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of”' in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. An apparatus for video decoding, comprising:
processing circuitry configured to:
determine a first region of interest (ROI) in a first reference picture of a current coding tree block (CTB) that is in a current picture;
determine a subset of allowable partition decisions from a set of partition decisions of the current CTB based at least on first partitioning structures of the first ROI in the first reference picture; and
partition the current CTB based on the subset of allowable partition decisions.

2. The apparatus of claim 1, wherein
the first ROI in the first reference picture is indicated by one of a motion vector and a block vector of a previously reconstructed neighboring CTB of the current CTB, the previously reconstructed neighboring CTB being in the current picture.

3. The apparatus of claim 1, wherein the first reference picture is the current picture.

4. The apparatus of claim 2, wherein the one of the motion vector and the block vector is the motion vector, and the first reference picture is different from the current picture.

5. The apparatus of claim 1, wherein the processing circuitry is configured to determine the subset of allowable partition decisions from the set of partition decisions of the current CTB based on at least (i) the first partitioning structures of the first ROI in the first reference picture and (ii) second partitioning structures of a second ROI in a second reference picture of the current CTB.

6. The apparatus of claim 2, wherein
the one of the motion vector and the block vector is the motion vector;
the first reference picture of the current CTB is different from a reference picture of the previously reconstructed neighboring CTB; and
the processing circuitry is configured to scale the motion vector based on a temporal distance associated with the first reference picture and a temporal distance associated with the reference picture of the previously reconstructed neighboring CTB.

7. The apparatus of claim 1, wherein a picture level quantization parameter (QP) associated with the first reference picture satisfies a pre-defined condition.

8. The apparatus of claim 1, wherein
a dual tree partitioning is applied to the first reference picture;
when the first partitioning structures of the first ROI include luma partitioning structures of a luma component in the first ROI, the processing circuitry is configured to determine the subset of allowable partition decisions from the set of partition decisions of the current CTB based on the luma partitioning structures of the first ROI; and
when the first partitioning structures of the first ROI include the luma partitioning structures of the luma component in the first ROI and chroma partitioning structures of a chroma component in the first ROI, the processing circuitry is configured to determine the subset of allowable partition decisions from the set of partition decisions of the current CTB based on the luma partitioning structures and the chroma partitioning structures of the first ROI.

9. The apparatus of claim 1, wherein
partitioning structures of each region in the first reference picture are stored in a look up table (LUT);
a size of each region is less than or equal to a maximum allowable block size; and
the processing circuitry is configured to obtain the first partitioning structures of the first ROI from the LUT.

10. The apparatus of claim 1, wherein the processing circuitry configured to:
determine the subset of allowable partition decisions from the set of partition decisions of the current CTB based on:
the first partitioning structures of the first ROI in the first reference picture and residuals associated with the first reference picture, or
the first partitioning structures of the first ROI in the first reference picture and at least one of (i) a quantization parameter (QP) associated with the first reference picture and a QP associated with the current picture, or
the first partitioning structures of the first ROI in the first reference picture and a temporal distance between the first reference picture and the current picture.

11. The apparatus of claim 1, wherein the current picture is one of an inter coded picture and an intra coded picture.

12. The apparatus of claim 1, wherein the processing circuitry is configured to:
determine contexts for entropy decoding control flags associated with respective partition decisions of the current CTB based at least on the first partitioning structures of the first ROI; and
determine partition decisions of the current CTB based on the control flags.

13. A method for video encoding, comprising:
determining a first region of interest (ROI) in a first reference picture of a current coding tree block (CTB) in a current picture;
determining a subset of allowable partition decisions from a set of partition decisions of the current CTB based at least on first partitioning structures of the first ROI in the first reference picture; and
partitioning the current CTB based on the subset of allowable partition decisions.

14. The method of claim 13, wherein
the first ROI in the first reference picture is indicated by one of a motion vector and a block vector of a previously reconstructed neighboring CTB of the current CTB, the previously reconstructed neighboring CTB being in the current picture.

15. The method of claim 13, wherein the first reference picture is the current picture.

16. The method of claim 14, wherein the one of the motion vector and the block vector is the motion vector, and the first reference picture is different from the current picture.

17. The method of claim 13, wherein the determining the subset of allowable partition decisions comprises:
determining the subset of allowable partition decisions from the set of partition decisions of the current CTB based on at least (i) the first partitioning structures of the first ROI in the first reference picture and (ii) second partitioning structures of a second ROI in a second reference picture of the current CTB.

18. The method of claim 14, wherein
the one of the motion vector and the block vector is the motion vector;
the first reference picture of the current CTB is different from a reference picture of the previously reconstructed neighboring CTB; and
the method includes scaling the motion vector based on a temporal distance associated with the first reference picture and a temporal distance associated with the reference picture of the previously reconstructed neighboring CTB.

19. The method of claim 13, wherein a picture level quantization parameter (QP) associated with the first reference picture satisfies a pre-defined condition.

20. A non-transitory computer-readable storage medium storing instructions which when executed by a processor cause the processor to perform an encoding method comprising:
determining a first region of interest (ROI) in a first reference picture of a current coding tree block (CTB) in a current picture;
determining a subset of allowable partition decisions from a set of partition decisions of the current CTB based at least on first partitioning structures of the first ROI in the first reference picture;
partitioning the current CTB based on the subset of allowable partition decisions; and
transmitting a bitstream including the current picture.
